(19) United States
(12) Patent Application Publication
(10) Pub. No.: US 2009/0230146 A1
(43) Pub. Date: Sep. 17, 2009

(54) LUBRICANT STORAGE AND DISPENSING SYSTEM

(75) Inventor: Gary A. Marcus, Hoffman Estates, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: JUSTRITE MANUFACTURING COMPANY, L.L.C., Des Plaines, IL (US)

(21) Appl. No.: 12/248,727

(22) Filed: Oct. 9, 2008

Related U.S. Application Data
(60) Provisional application No. 60/998,207, filed on Oct. 9, 2007.

(51) Int. Cl. B67D 5/06

(52) U.S. Cl. 222/23

(57) ABSTRACT

A lubricant storage and dispensing system includes at least one vessel having a mouth with a threaded surface, at least one lid with a threaded surface adapted to sealingly engage the threaded surface of at least one vessel, at least two color-coded cards, each card being a different color than the other cards, and a plurality of color-coded band corresponding in number and respective color to the color-coded cards. A color-coded card can be associated with each of the vessels of the system. The corresponding color-coded band can be placed on the lid sealingly mounted to the vessel.

### CROSS-REFERENCE TO RELATED APPLICATIONS

This patent application claims the benefit of priority to U.S. Provisional Patent Application No. 60/998,207, filed Oct. 9, 2007, and entitled “Lubricant Storage and Dispensing System,” which is incorporated herein in its entirety by this reference.

### FIELD OF THE INVENTION

The present invention pertains generally to a storage and dispensing system, and more particularly, to a lubricant storage and dispensing system.

### BACKGROUND OF THE INVENTION

Lubrication contamination is a leading cause of machinery failure. It would be advantageous to avoid the contamination of equipment rather than remove the contamination after ingression. There is a general need in the art for an improved lubricant storage and dispensing system.

### SUMMARY OF THE INVENTION

This disclosure describes, in one aspect, a lubricant storage and dispensing system. The lubricant storage and dispensing system can include a plurality of containers with each container having a mouth defining an opening for access to the interior of the container. The system can include a plurality of lids with each lid being configured to sealingly mount to at least one of the containers. A plurality of identification cards can be provided. Each card can have at least one colored side with the color thereon being different than the colors of the other colored sides. A plurality of colored bands can be provided. The number and color of the bands can correspond to the colored sides of the identification cards such that each colored band is the color of one of the colored sides of the identification cards and each colored side has a corresponding colored band. Each colored band can be mountable upon at least one of the lids. Each identification card can be displayable upon at least one of the containers such that a selected colored side of the identification cards is displayed outwardly.

In another aspect, a lubricant storage and dispensing device is described. The lubricant storage and dispensing device can include a container, a lid, at least one identification card, and at least one colored band. The container can have a mouth defining an opening for access to the interior of the container. The lid can be configured to sealingly mount to the mouth of the container. Each card can have at least one colored side with the color thereon being different than the color of each of the other colored sides. The number and color of the colored bands can correspond to the number and color of the colored sides of the identification cards such that each colored band is the color of one of the colored sides of the identification cards and each colored side. has a corresponding colored band. Each colored band is mountable upon the lid. Each identification card is displayable upon the container such that a selected colored side of the identification card is displayed outwardly.

These and other objects and advantages, as well as additional inventive features, of the present invention will become apparent to one of ordinary skill in the art upon reading the detailed description, in conjunction with the accompanying drawings, provided herein.

### BRIEF DESCRIPTION OF THE DRAWINGS

FIG. 1 is a perspective view of an embodiment of a lubricant storage and dispensing system according to the principles of the present disclosure.

FIG. 2 is a side view of an embodiment of a lid suitable for use with a lubricant storage and dispensing system in accordance with the principles of the present disclosure.

FIG. 3 is a top view of the lid of FIG. 2.

FIG. 4 is a bottom view of the lid of FIG. 2.

FIG. 5 is an enlarged, fragmentary view of a spout of the lid of FIG. 2 with a discharge valve removed for illustrative purposes.

FIG. 6 is an elevational view of the discharge valve of the lid of FIG. 2.

FIG. 7 is a first elevational view of an identification card suitable for use with a lubricant storage and dispensing system according to the principles of the present disclosure that shows a first side of the identification card having a first color.

FIG. 8 is a second elevational view of the identification card of FIG. 7 showing a second side thereof having a second color that is different than the first color of the first side of the identification card.

FIG. 9 is a perspective view of an embodiment of a lubricant storage and dispensing device that includes the lid of FIG. 2 outfitted with a colored band and sealingly mounted to a container and a plurality of bands having different colors.

### DETAILED DESCRIPTION OF EMBODIMENTS OF THE INVENTION

In accordance with the principles of this disclosure, a lubricant storage and dispensing system can be provided that includes at least one vessel having a mouth with a threaded surface, at least one lid with a threaded surface adapted to sealingly engage the threaded surface of at least one vessel, at least two color-coded identification cards, each card having a surface that is a different color than the color of the other cards, and a plurality of color-coded elastomeric bands corresponding, respectively, to the color to the color-coded cards. One of the color-coded identification cards can be mounted to one of the vessels of the system such that the color-coded identification card displays a particular color outwardly. The corresponding color-coded band can be placed on the lid sealingly mounted to the vessel.

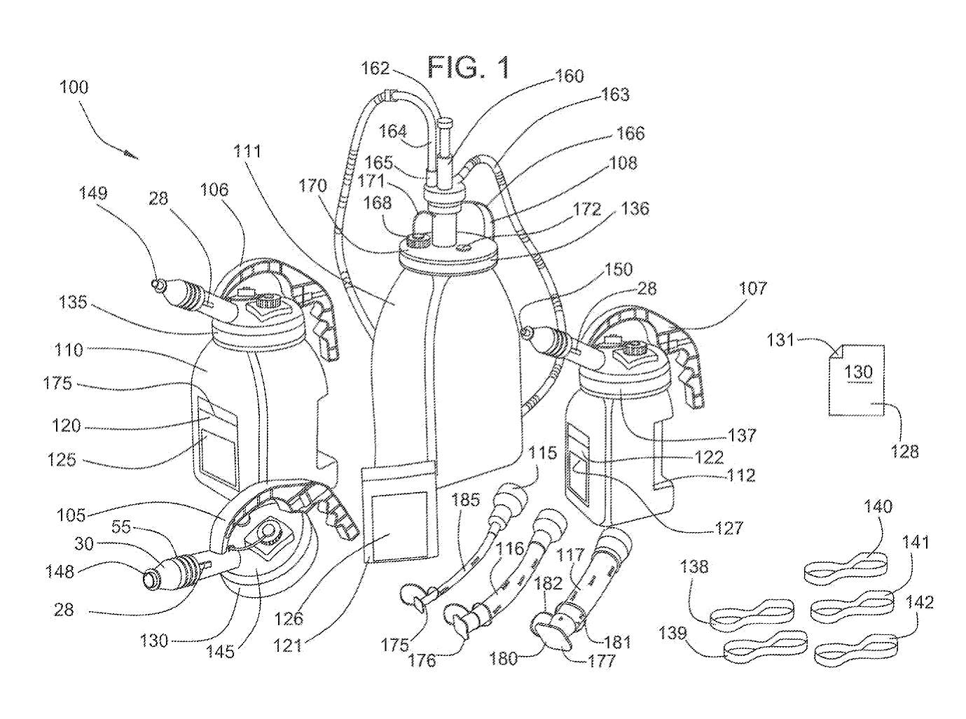

Turning now to the drawings, there is shown in FIG. 1 an illustrative embodiment of a lubricant storage and dispensing system 100 is shown. The lubricant storage and dispensing system 100 includes a plurality of lids 105, 106, 107, 108, a plurality of containers 110, 111, 112, a plurality of flexible extension hoses 115, 116, 117, a plurality of data pouches 120, 121, 122, a plurality of identification cards 125, 126, 127, 128, each configured to fit within each of the data pouches 120, 121, 122 and each having two sides 130, 131 each with a different color thereon, and a plurality of colored bands 135, 136, 137, 138, 139, 140, 141, 142 with the number of colored bands corresponding to the number and respective different colors of the identification cards.

The lids 105, 106, 107, 108 and the containers 110, 111, 112 are each configured such that each lid can be sealingly mounted to each of the containers. Each one of the data pouches 120, 121, 122 can be mounted to any one of the containers 110, 111, 112. Each one of the extension hoses 115, 116, 117 can be removably mounted to at least one of the lids 105, 106, 107 having a spout 28. Each colored band 135, 136, 137, 138, 139, 140, 141, 142 is adapted to be removably mounted to the body of each one of the lids 105, 106, 107, 108.

The containers 110, 111, 112 can each be a different size. For example, the first container 110 can have a 5-quart capacity, the second container 111 can have a 10-quart capacity, and the third container 112 can have a 2-quart capacity. Each container can include a mouth that defines an opening for access to the interior of the container. Each mouth can include an external threaded surface for threaded engagement with each one of the lids, respectively, such that each container 110, 111, 112 can be sealingly arranged with each one of the lids 105, 106, 107, 108.

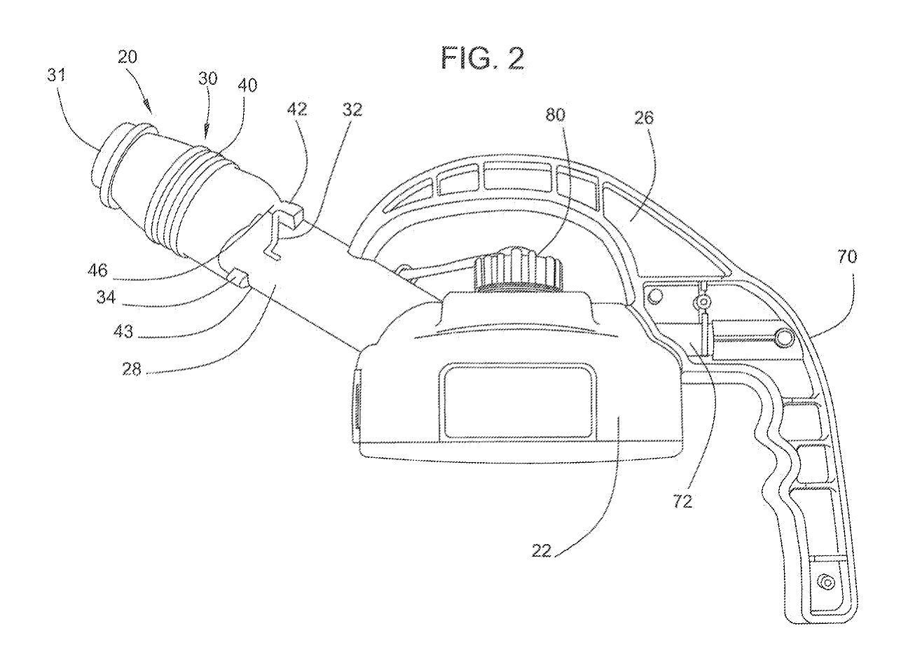

Each lid includes a body 145 that includes an internal threaded surface that can be matingly, threadedly engaged with the external threaded surface of each one of the containers 110, 111, 112. In the illustrative system 100, three lids 105, 106, 107 are constructed similarly to the lid 20 shown in FIG. 2. Each of these lids 105, 106, 107 can have a nozzle opening with a different size. For example, the first pour lid 105 can have a nozzle opening 148 that is one inch in diameter, the second pour lid 106 can have a nozzle opening 149 that is one-half inch in diameter, and the third pour lid 107 cal have a nozzle opening 150 that is one quarter inch in diameter.

The other lid 108 can comprise a pump mechanism 160. The pump can include a piston-style hand pump 162 for pumping liquid stored in the container 111 through flexible hose 163. The flexible hose 163 can include an aluminum tip 164 that can be removably stored in a socket 165 defined in the pump lid 108. Tile pump lid 108 can include a handle portion 166 and a removable cap 168 for selectively covering a fill port extending through a body 170 of the lid 108. The cap 168 can be secured to the pump lid 108 by a tether 171 to help prevent the loss of the cap 168. The body 170 of the pump lid 108 includes a threaded surface oil its interior for threaded, sealing engagement with each of the containers 110, 111, 112. The body 170 can include an additional port 172 which can include an internal threaded surface, such as a one-half inch NPT female thread, for example. A plug 172 can be threaded into the accessory port to selectively close the port. The fill port covered by the cap 168 and the second port 172 can be different sizes, such as ½ inch and ⅜ inch diameters, for example. The second port 172 can receive a quick disconnect coupling.

Each extension hose 115, 116, 117 can have a different pour spout opening to match the different nozzle. sizes in the system, for example. For example, the first extension hose 115 can have a pour spout opening 175 that is one quarter inch in diameter, the second extension hose 116 can have a pour spout opening 176 that is one-half inch in diameter, and the third extension hose 117 can have a pour spout opening 177 that is one inch in diameter. Each of the pour spout openings 175, 176, 177 of the extension hoses 115, 116, 117 can be selectively covered with a removable cap 180 that is tethered to the extension hose via a ring 181 encircling the hose 117 and a strap 182 connecting the ring 181 and the cap 180. The extension hoses 115, 116, 117 can each be mounted to the spouts 28 of the pour lids 105, 106, 107 via a threaded engagement between an external threaded surface 55 on a discharge valve 30 of the spout of the pour lid and an internal threaded surface disposed within a socket 185 of each of the extension hoses 115, 116, 117.

Each of the data pouches 120, 121, 122 can be affixed to one of the corresponding containers 110, 111, 112 via an adhesive backing on the pouch, for example. Each pouch includes an opening 175 for allowing access to the interior of the pouch. Four different color-identification cards 125, 126, 127, 128 can be provided with each associated container. Each data pouch 120, 121, 122 can be constructed from a clear plastic, floor example, such that the color-identification card stored within the pouch can be visible through the data pouch. In other embodiments, the data pouch can be equipped with an opening having a zipper associated with it such that the opening can be selectively opened and closed to allow access into the interior of the pouch and to prevent any data cards disposed therein from inadvertently slipping out of the pouch, respectively. Each data pouch can be constructed such that it can store a plurality of color-identification cards and a material safety data sheet associated with the material being stored within the particular container in questions, preventative maintenance lubrication records and/or operating instructions, for example.

Each color-identification card 125, 126, 127, 128 can have a different color displayed on each side thereof such that, in the illustrative embodiment, a total of eight different color choices are available. For example, the first color-identification card 125 can have one side that is purple and the other side that is orange. The second color-identification card 126 can have a first side that is yellow mid a second side that is red. The third color-identification card 127 can have a first side that is blue and a second side that is green. The fourth color-identification card 128 can have a first side that is brown and a second side that is grey. In other embodiments, the identification card can have the same color oil each side. In yet other embodiments, the number and color arrangement of each card can be varied.

The system 100 includes a colored band corresponding to each color of the color-identification cards 125, 126, 127, 128. Accordingly, the illustrative system 100 includes eight colored bands with each being a different color of the colors red, orange, yellow, green, blue, purple brown, and grey. Each band can be made from an elastomeric material such that the band can be readily wrapped around the body of a selected lid and snugly mounted thereto. Each band is constructed such that it can be removably mounted to the body of each one of the lids 105, 106, 107, 108 of the system.

In use, the user can associate a particular color with a particular lubricant or other fluid for use with the system 100. The user can designate one of the containers 110, 111, 112 and one of the lids 105, 106, 107, 108 for use With the selected lubricant. The user can select one of the color-identification cards 125, 126, 127, 128 bearing the selected color for that fluid and displaying the particular color chosen in the data pouch associated with the selected container such that the color is visibly displayed in the pouch. The colored band having the same color can be removably mounted to the selected lid. The container can be filled with the selected lubricant, and the selected lid can be sealingly engaged with the selected container.

For example, the first container 110 has the color-identification card 125 with its first side 130 being purple visibly displayed within the pouch 120. The second pour lid 106 is equipped with the purple band 135 and is sealingly mounted to the first container 110. In situations where the user intends to use multiple containers for the same kind of lubricant, a plurality of identification cards having at least one side with the same color and a corresponding number of same-colored bands can be provided in the system.

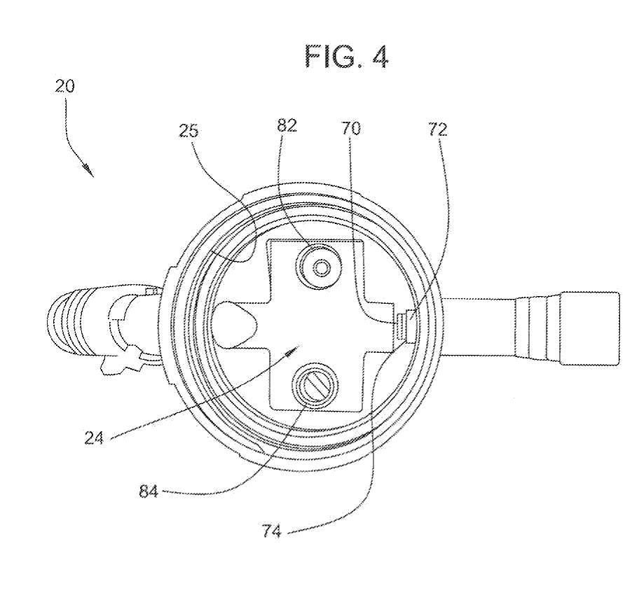

Referring to FIG. 2, an illustrative lid 20 suitable for use with a lubrication storage and dispensing system according to the principles of this disclosure is shown. The lid 20 shown in FIG. 2 is similar in construction and operation to the lids 105, 106, 107 shown in FIG. 1. The lid 20 can be made from any suitable material such as plastic, for example, including a high-density polyethylene material. Referring to FIG. 2. the lid 20 is configured to sealingly fit over a container. The lid 20 includes a body 22 defining a cavity 24 with a threaded internal surface 25 (FIG. 4), a handle portion 26, and a spout 28. The spout 28 includes a variable discharge valve 30 mounted thereto that can selectively vary the flow rate of the liquid from the container through the spout 28 out of a nozzle opening 31 of the discharge valve 30.

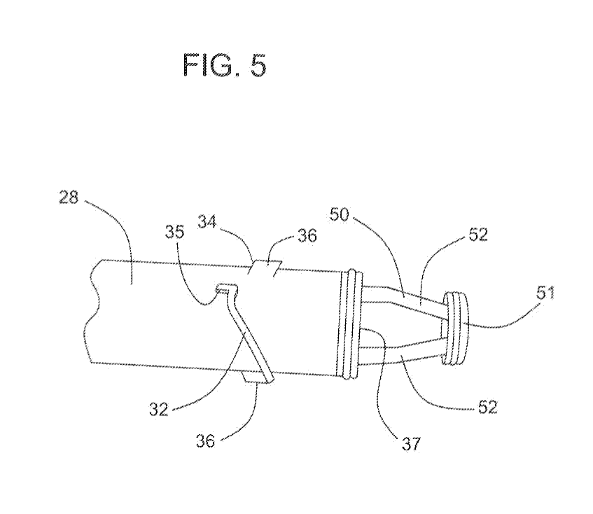

Referring to FIGS. 2 and 5, the Spout 28 includes a first rail 32 and a second rail 34 that extend along an outside surface of the cylindrical spout 28 for mounting the discharge valve 30 thereto. Each rail 32, 34 includes a pair of stops 35, 36 adapted to interferingly engage the variable discharge valve 30 to define a fully opened position and a fully closed position. In the illustrative embodiment, the first stops 35 define the closed position, and the second stops 36 define the fully opened position. Each rail 32, 34 extends along an inclined path between the first and second stops 35, 36 such that the second stop 36 is disposed a predetermined distance distally away from the first stop 35.

The spout 28 includes a distal opening 37 which is in fluid communication with the interior of the spout 28 to allow fluid to exit from the spout via the opening 37. An inner portion 50 is mounted to the distal end of the spout 28. The inner portion 50 includes an end plate 51 disposed in spaced relationship to the opening 37 by a plurality of support posts 52.

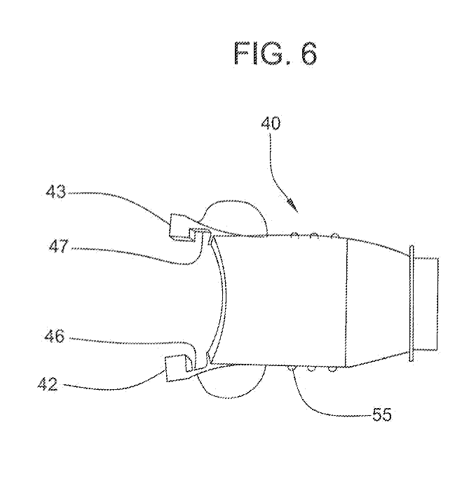

Referring to FIGS. 2 and 6, the discharge valve 30 includes an outer portion 40 with first and second flanges 42, 43 that include a respective first and second notch 46, 47. The outer portion 40 of the discharge valve is rotatably mounted to the spout 28 via the first and second rails 32, 34. The first and second rails 32, 34 are respectively disposed in the first and second notches 46, 47 such that the outer portion 40 is rotatably mounted to the spout 28 with the outer portion rotatable about the spout between first and second positions which correspond to the fully closed position and the fully open position of the discharge valve 30.

The outer portion 40 of the discharge valve can travel between the first and second positions along a path of travel defined by the, rails 32, 34 to vary an outlet opening defined by the inner portion 50 (FIG. 5) and the nozzle opening 31 of the outer portion 40 of the discharge valve 30. When the outer portion 40 is in the first position, the nozzle opening 31 of the outer portion 40 is in proximate relationship to the end plate 51 of the inner portion 50 such that the nozzle opening is closed to prevent the flow of liquid from the variable discharge valve 30. When the outer portion 40 is in the second position, the nozzle opening 31 is in maximum offset relationship with the end plate 51 such that the discharge valve 30 is in the fully opened position. As the outer portion 40 moves from the first to the second position, the distance between the end plate 51 and the nozzle opening 31 will incrementally increase to variably open; the valve increasing the nozzle opening until the discharge valve the valve 36 is fully open.

The socket 185 of each extension hose 115, 116, 117, 118 can be configured such that the outer portion 40 fits within the interior thereof. The outer portion 40 includes an external threaded surface 55 which can be threadedly mated with the interior threaded surface of each one of the extension hoses 115, 116, 117 of the storage system 100, for example.

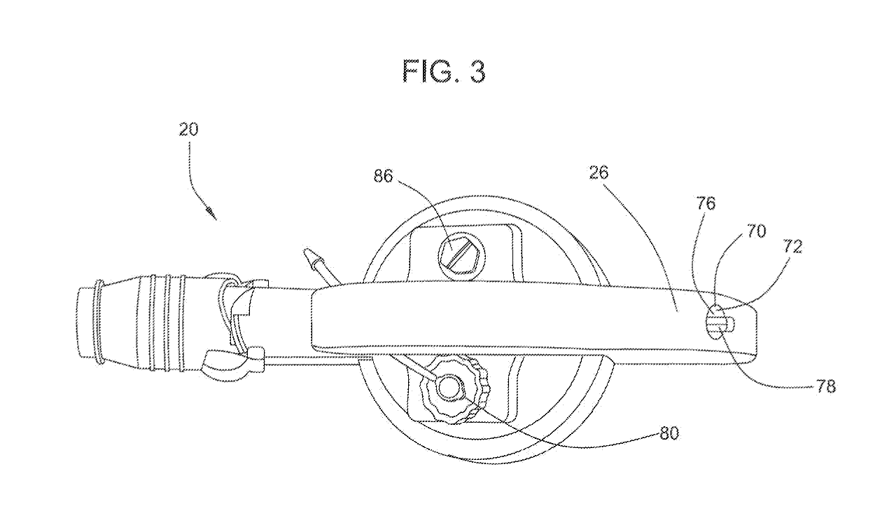

Referring( to FIGS. 2-4, the lid 20 also includes an air bleed valve 70 disposed within an air bleed passage 72. The air bleed passage 72 extends between the cavity 24 and the outside environment. Referring to FIG. 4, the passage 72 includes a first opening 74 disposed. on the inside surface of the cavity 24. Referring to FIG. 3, the passage 72 includes a second opening 76 disposed on the outer surface of the handle 26. An actuator 78 is provided to allow the air bleed valve 70 to move between an open position wherein the air bleed passage 72 is open and a closed position wherein the air bleed passage 72 is closed.

Referring to FIGS. 2 and 3, the lid 20 can include a removable cap 80 for selectively covering a fill port 82 (FIG. 4). The cap 80 can be threadedly mounted to the body 22 of the lid 20. The fill port 82 can be used to refill the container to which the lid 20 is sealingly mounted to reduce the exposure of the interior of the container (arid the liquid stored therein) to airborne contaminants by avoiding the need to remove the lid to refill the container. The lid can include an accessory port 86 (FIG. 4) selectively closed via a plug 86 with a slotted head. The accessory port 84 can receive a quick disconnect coupling that can be threadedly engaged therewith to facilitate the filling of the container to which the lid is sealingly mounted.

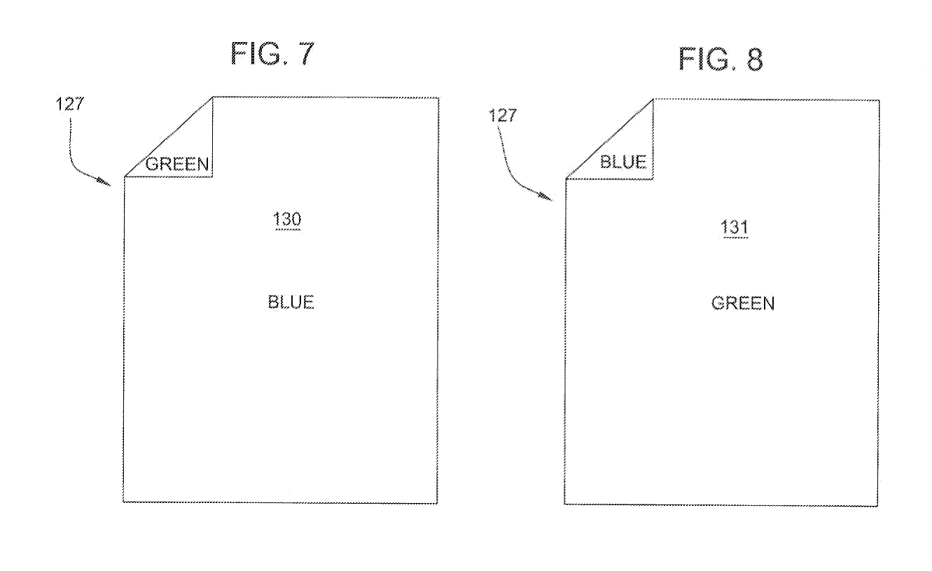

Referring to FIGS. 7 and 8, an illustrative identification card 127 is shown. Referring to FIG. 7, the first side 130 of the identification card 127 is blue. Referring to FIG. 8, the second side 131 of the identification card 127 is green.

In other embodiments of the lubricant storage and dispensing system, the number of lids and/or containers can be varied. In addition, in other embodiments, the number of extension hoses can be varied.

In other embodiments, an additional set of color-identification cards can be provided for each container. The additional color-identification cards can be used to further color code a supply of the lubricant that each container is intended to hold such that the lubricant supply from which the container is filled can be associated with the same color, such as by having a data pouch mounted thereto that contains the appropriate color-identification card, for example, so that each of the container, the lid, and the lubricant supply all bear the same color.

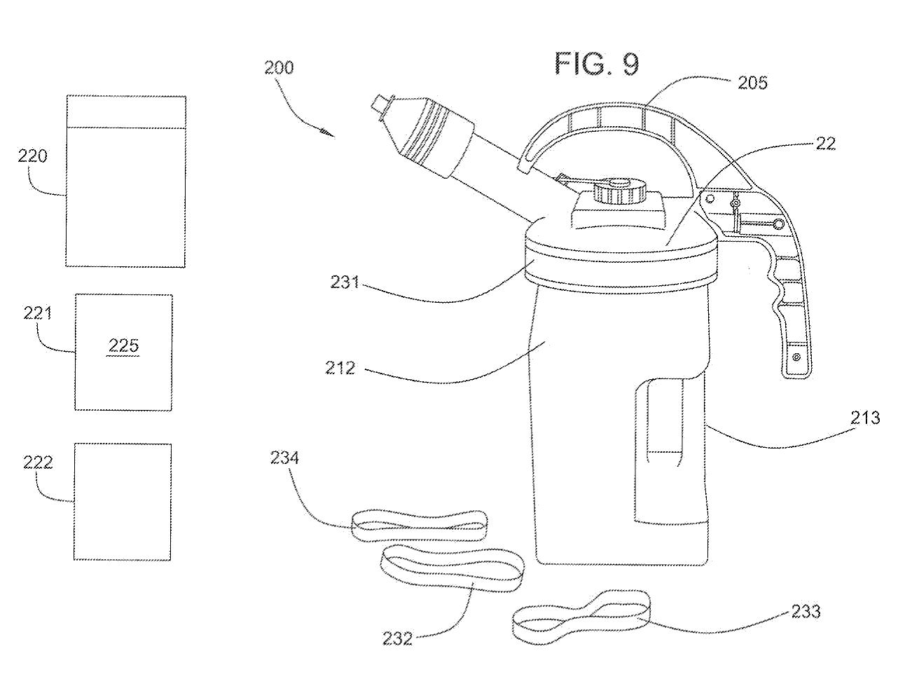

Referring to FIG. 9, an embodiment of a lubricant storage and dispensing device 200 is shown. The lubricant storage and dispensing device 200 includes a lid 205 sealingly mounted to a mouth of a container 212, a data pouch 220, a plurality of color-identification cards 221, 222, and a plurality of colored bands 231, 232, 233, 234. The lid 205 can be similar in construction to the pour lid 20 shown in FIG. 2.

The identification cards 221, 222 are similar to the identification cards 125, 126, 127, 128 shown in FIG. 1. The data pouch can be affixed to the container 212 in a fashion similar to that described above. At least one identification card 221, 222 can be stored in the data pouch 220 affixed to the container 212 such that a colored side of the identification card is visible through the sidewall of the data pouch. A colored band corresponding to the color visible in the data pouch affixed to the container 212 can be mounted to the lid 205.

For example, the green band 231 is mounted to the body 22 of the lid 205. The first side 225 of the identification card 221 is green. The first identification card 221 can be inserted into the data pouch 220 such that the first side 225 is displayed outwardly.

In other embodiments, the lid of the lubricant storage and dispensing device can be similar in construction to the pump lid 108 shown in FIG. 1, for example, or have another construction. The container 212 can be similar to one of the containers 110, 111, 112 shown in FIG. 1, for example. In other embodiments, the container can have a different configuration. The container 212 includes an integral handle 213.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly. this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A lubricant storage and dispensing system comprising:
a plurality of containers; each container having a Mouth defining an opening for access to the interior of the container;
a plurality of lids, each lid being configured to sealingly mount to at least one of the containers;
a plurality of identification cards, each card having at least one colored side with the color thereon being different than the colors of the other colored sides;
a plurality of colored bands, the number and color of the bands corresponding to the colored sides of the identification cards such that each colored band is the color of one of the colored sides of the identification cards and each colored side has a corresponding colored band;
wherein each identification card is displayable upon at least one of the containers such that a selected colored side of the identification card is displayed outwardly, and wherein each colored band is mountable upon at least one of the lids.

2. The lubricant storage and dispensing system of claim 1 wherein at least one of the containers is a different size than at least one of the other containers.

3. The lubricant storage and dispensing system of claim 1, wherein at least one of the lids includes a spout.

4. The lubricant storage and dispensing system of claim 3, further comprising:
a flexible hose, the hose having a first end adapted to be mountable to the spout of the lid and a second end defining a pour spout opening.

5. The lubricant storage and dispensing system of claim 3, wherein the spout includes a variable discharge valve.

6. The lubricant storage and dispensing system of claim 5, wherein the at least one of the lids that includes a spout includes an air bleed passage with an air bleed valve disposed therein.

7. The lubricant storage and dispensing system of claim 1, wherein at least one of the lids includes a pump mechanism.

8. The lubricant storage and dispensing system of claim 1, wherein at least one of the lids includes a body having a fill port extending therethrough and a removable cap for selectively covering the fill port.

9. The lubricant storage and dispensing system of claim 1, wherein at least one of the identification cards includes two sides, each side having a different color.

10. The lubricant storage and dispensing system of claim 9, wherein each of the identification cards includes two sides, each side of each identification card having a different color than the other colors the other sides.

11. The lubricant storage and dispensing system of claim 1, further comprising:
a plurality of data pouches, the number of data pouches corresponding to the number of containers, each data pouch being mountable to at least one of the containers such that each container has a data pouch mounted thereto, the data pouch being configured to receive at least one of the identification cards such that the colored side of the identification card received therein is visible.

12. A lubricant storage and dispensing device comprising:
a container, the container having a mouth defining an opening for access to the interior of the container;
a lid, the lid being configured to sealingly mount to the mouth of the container;
at least one identification card, each card having at least one colored side with the color thereon being different than the color of each other colored side;
at least one colored band, the number and color of the colored bands corresponding to the colored sides of the identification cards such that each band is the color of one of the colored sides of the identification cards and each colored side has a corresponding colored band;
wherein each identification card is displayable upon the container such that a selected colored side of the identification card is displayed outwardly, and wherein each colored band is mountable upon the lid.

13. The lubricant storage and dispensing device of claim 12, wherein the lid includes a spout.

14. The lubricant storage and dispensing device of claim 13, wherein the spout includes a variable discharge valve.

15. The lubricant storage and dispensing device of claim 14, wherein the lid includes an air bleed passage with an air bleed valve disposed therein.

16. The lubricant storage and dispensing device of claim 12, wherein the lid includes a pump mechanism.

17. The lubricant storage and dispensing device of claim 12, wherein the lid includes a body having a fill port extending therethrough and a removable cap for selectively covering the fill port.

18. The lubricant storage and dispensing device of claim 12, wherein at least one of the identification cards includes two sides, each side having a different color.

19. The lubricant storage and dispensing device of claim 18, wherein each of the identification cards includes two sides, each side of each identification card having a different color than the other colors the other sides.

20. The lubricant storage and dispensing device of claim 12, further comprising:
a data pouch, the data pouch being mountable to the container, the data pouch being configured to receive at least one of the identification cards such that the colored side of the identification card received therein is visible.
